(19) United States
(12) Patent Application Publication
(10) Pub. No.: US 2026/0225786 A1
(43) Pub. Date: Aug. 6, 2026

(54) LIQUID CONTAINER

(71) Applicant: BROTHER KOGYO KABUSHIKI KAISHA, Nagoya (JP)

(72) Inventor: Hideaki YOSHIMUNE, Nagoya (JP)

(73) Assignee: BROTHER KOGYO KABUSHIKI KAISHA, Nagoya (JP)

(21) Appl. No.: 19/630,668

(22) Filed: Mar. 27, 2026

Related U.S. Application Data
(63) Continuation of application No. PCT/JP2025/001744, filed on Jan. 21, 2025.

(30) Foreign Application Priority Data
Jan. 31, 2024 (JP) 2024-013264

(51) Int. Cl. B65D 75/58; B41J 2/175; B65D 41/04

(52) U.S. Cl. CPC B65D 75/5883; B41J 2/17513; B41J 2/17523; B41J 2/17553; B41J 2/17596; B65D 41/04; B41J 2002/17516; B65D 2575/586

(57) ABSTRACT

A liquid container includes a container body including an outlet; and a screw cap. The outlet includes a projection. The screw cap includes: a first convex part which has an inclined part configured to allow the projection to pass through in a case where the screw cap is rotated in a first direction of a rotation direction to be screwed into the outlet and an interfering part configured to interfere with the projection to prevent the screw cap from rotating in a second direction opposite to the first direction; and a second convex part configured to allow the projection to pass through, and come into contact with the projection to cause a friction force in the rotation direction, in a case where the screw cap is screwed into the outlet.

### REFERENCE TO RELATED APPLICATIONS

This application is a Continuation Application of International Application No. PCT/JP2025/001744 filed on January 21, 2025 that claims the conventional priority of Japanese patent Application No. 2024-013264 filed on January 31, 2024. The entire content of Japanese patent Application No. 2024-013264 and the entire content of International Application No. PCT/JP2025/001744 are incorporated herein by reference.

### BACKGROUND ART

A container for toner refilling in which a projection for preventing reverse rotation is provided on a mouth part of a container body containing toner is known. In such a container, a cap part is composed of a first cap part provided with an engagement part and a second cap part provided with an engagement projection configured to restrain reverse rotation of the cap part by being engaged with the projection for preventing reserve rotation; and the first cap part and the second cap part are capable of separating from each other.

### SUMMARY

However, in the container for toner refilling described above, the reverse rotation of the cap part is prevented after the cap part has been attached to the mouth part of the container body, and thus adjusting a positional relationship between the cap part and the container body after the cap part has been attached to the mouth part of the container body is difficult.

A purpose of the present disclosure is to provide a technique by which adjustment of a positional relationship between a screw cap and a container body is made possible while preventing a reverse rotation of the screw cap, in a case where the screw cap is screwed into an outlet of the container body.

According to a first aspect of the present disclosure, there is provided a liquid container including: a container body including an outlet having a cylindrical shape, a male screw being formed on an outer circumferential surface of the outlet; and a screw cap having a cylindrical shape, a female screw being formed on an inner circumferential surface of the screw cap, the screw cap being configured to be screwed into the outlet in a state that the outer circumferential surface of the outlet and the inner circumferential surface of the screw cap face each other. The outlet includes a projection disposed, on the outer circumferential surface of the outlet, at a position adjacent to a base of the cylindrical shape of the outlet. The screw cap includes: a first convex part which is disposed on the inner circumferential surface of the screw cap and which has an inclined part and an interfering part, the inclined part being configured to allow the projection to pass through the first convex part in a case where the screw cap is rotated in a first direction of a rotation direction to be screwed into the outlet, the interfering part being configured to interfere with the projection to prevent the screw cap from rotating in a second direction, opposite to the first direction, of the rotation direction; and a second convex part configured to allow the projection to pass through the second convex part, and to come into contact with the projection so as to cause a friction force in the rotation direction, in a case where the screw cap is screwed into the outlet.

According to the present disclosure, adjustment of a positional relationship between a screw cap and a container body is made possible while restraining a reverse rotation of the screw cap, in a case where the screw cap is screwed into an outlet of the container body.

### BRIEF DESCRIPTION OF DRAWINGS

FIG. 1 is a perspective view depicting an outward appearance of a liquid container.

FIG. 2 is a partial cross-sectional view along X-X line of FIG. 1.

FIG. 3 is a perspective view depicting a cartridge case containing the liquid container of FIG. 1.

FIG. 4A is a perspective view depicting a state in which the cartridge case of FIG. 3 is being inserted into an ink supply unit. FIG. 4B is a perspective view depicting a state in which the cartridge case of FIG. 3 is received in the ink supply unit.

FIG. 5 depicts a state in which a screw cap is screwed into an outlet of the liquid container of FIG. 1.

FIG. 6A and FIG. 6B each depict a state in which a screw cap is screwed into an outlet having projections of which number is different from the number of projections of the liquid container of FIG. 1.

### DESCRIPTION

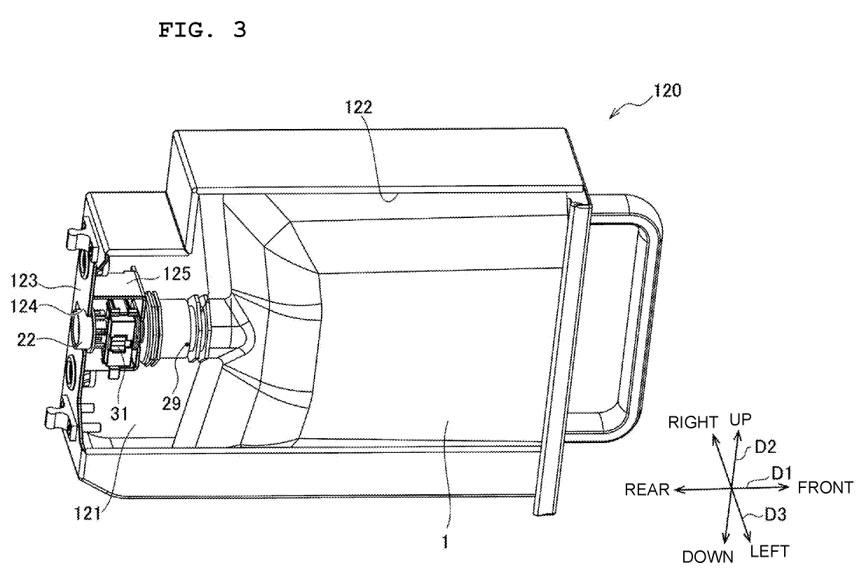

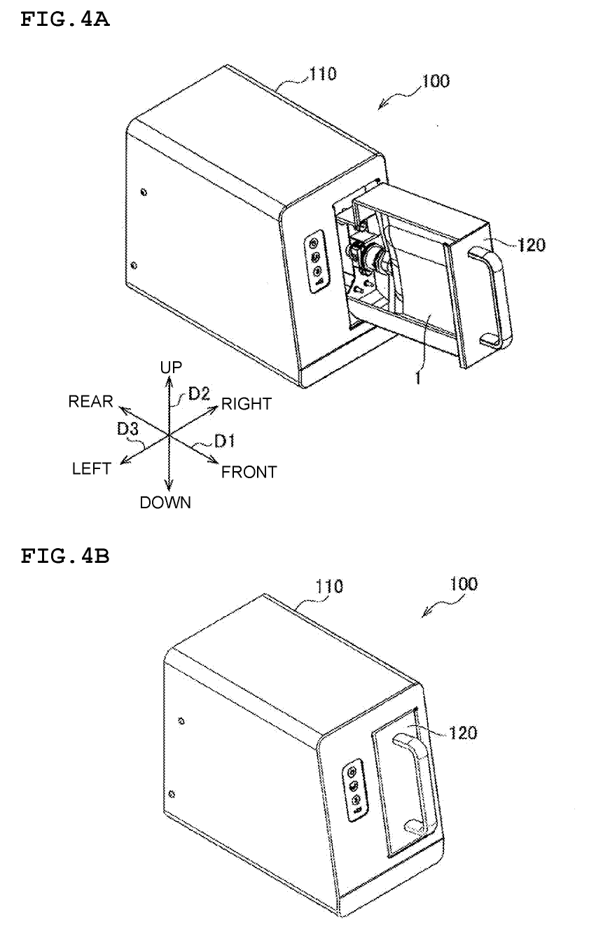

In the following, an embodiment of the present application will be described in detail based on the drawings. In the drawings used for the following description, some of the basic configurations may be omitted, and the dimensional ratios, etc. of the depicted parts are not necessarily accurate. In FIG. 3 and FIG. 4, the front-rear direction D1, the up-down direction D2, and the left-right direction D3 are defined as indicated in the respective drawings.

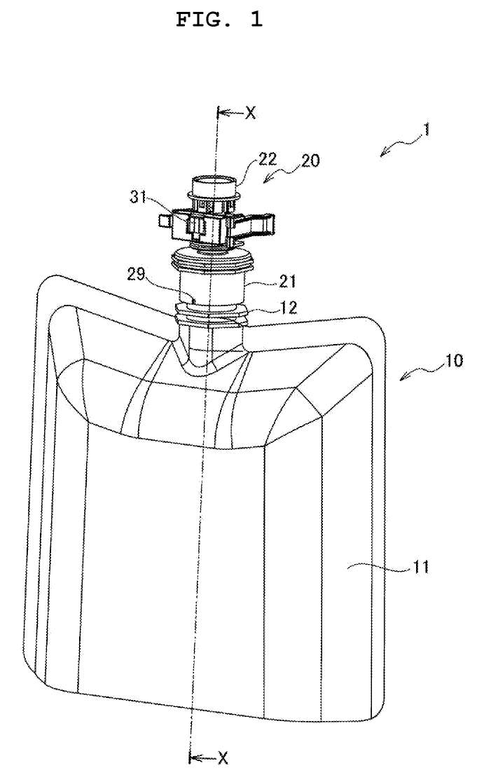

FIG. 1 depicts the outward appearance of a liquid container 1 according to an embodiment of the present disclosure. The liquid container 1 is, for example, a container for containing a UV ink being an ink of ultraviolet curing type. In the following description, the liquid container 1 is referred to as an ink container 1.

As depicted in FIG. 1, the ink container 1 has a configuration in which a screw cap 20 is attached to a container body 10. The container body 10 has a configuration in which an outlet 12 having a cylindrical shape and made of resin is attached to a pouch 11 made of film material. The ink will be contained in the pouch 11. The pouch 11 is formed such that a width of the pouch 11 is greater than a thickness of the pouch 11.

The screw cap 20 is a cap configured to cover the outlet 12 by being screwed into the outlet 12 from the outside of the outlet 12. The screw cap 20 includes a screw cap body 21 having a cylindrical shape, and an ink outlet part 22 disposed on the screw cap body 21 to stand on the screw cap body 21.

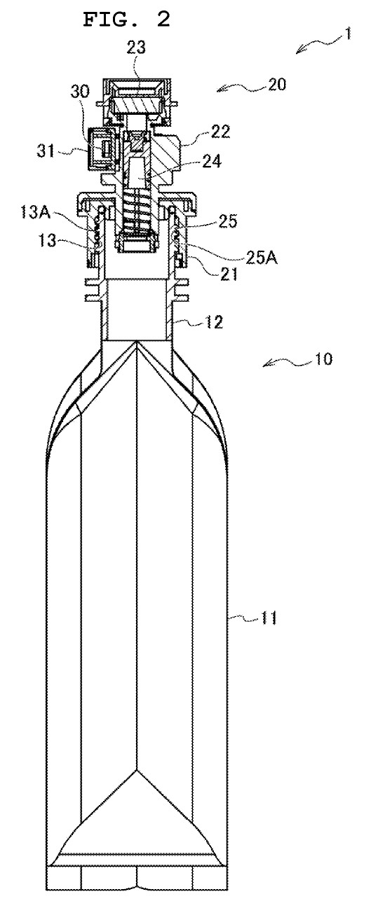

FIG. 2 is a partial cross-sectional view along the X-X line of FIG. 1. As depicted in FIG. 2, the inner diameter of the screw cap body 21 is set to be larger than the outer diameter of the outlet 12. A female screw 25A is screw cut onto the inner circumferential surface 25 of the screw cap body 21, and a male screw 13A is screw cut onto the outer circumferential surface 13 of the outlet 12. As a result, the screw cap 20 can be attached to the outlet 12 by screwing the screw cap 20 into the outlet 12 in a state that the inner circumferential surface 25 of the screw cap body 21 and the outer circumferential surface 13 of the outlet 12 facing each other.

The ink outlet part 22 has a receiving hole 23 into which a hollow needle (not depicted) can be inserted from the outside, and a valve mechanism 24 that opens or closes depending on whether the hollow needle inserted into the receiving hole 23 presents or not. An IC memory 30 is attached to the inside of the ink outlet part 22. The IC memory 30 stores various information on the ink in the pouch 11, such as information on the type of the ink, the capacity, date of manufacture, etc. A contact 31 of the IC memory 30 is disposed so as to expose to the outside on the surface of the screw cap 20, as depicted in FIG. 1.

A marker 29, having recessed shape, for aligning a positional relationship between the screw cap 20 and the container body 10 is formed on the outer circumferential surface of the screw cap body 21. The marker 29 is located at a position aligned with the center of the contact 31 of the IC memory 30 as seen in a direction in which the hollow needle is inserted. That is, the mark 29 is disposed for aligning the orientation of the contact 31 of the IC memory 30 and the orientation of the container body 10.

Next, the using method of the ink container 1 will be described based on FIG. 3 and FIG. 4. As depicted in FIG. 3, the ink container 1 is housed in the cartridge case 120 so that the width direction of the container body 10 of the ink container 1 matches the up-down direction of the cartridge case 120. The cartridge case 120 has a housing chamber 121 that houses the ink container 1. The housing chamber 121 has an opening 122 defined on one side surface (left side surface in the example in FIG. 3) of the housing chamber 121, and the ink container 1 is housed in the housing chamber 121 via the opening 122. A hole 124 for exposing the ink outlet part 22 to the outside of the housing chamber 121 is defined on a rear surface 123 defining the housing chamber 121. A holding part 125 for holding the ink outlet part 22 is formed at a position adjacent to the hole 124 in the housing chamber 121. The ink outlet part 22 is held by the holding part 125 in a state that the contact 31 is exposed to the outside via the opening 122.

The cartridge case 120 containing the ink container 1 is inserted into a unit housing 110 from a position in front of an ink supply unit 100, as depicted in FIG. 4A, and is housed in the unit housing 110 as depicted in FIG. 4B.

The ink supply unit 100 is configured to be connectable via a cable (not depicted), for example, to a recording head (not depicted) configured to eject the ink to perform recording (printing) on a recording medium. The ink supply unit 100 supplies the ink in the ink container 1 to the recording head.

The ink supply unit 100 includes the above described hollow needle disposed inside the unit housing 110. In a case where the cartridge case 120 containing the ink container 1 is housed in the unit housing 110, the hollow needle is inserted into the receiving hole 23 of the ink outlet part 22. Accordingly, the valve mechanism 24 turns to an open state, and a state in which the ink in the ink container 1 can be poured out by the hollow needle is realized. A pump (not depicted) for transporting the ink and a controller (not depicted) for controlling the pump are provided in the unit housing 110. For example, in a case where the user instructs the starting of the ink supply, the controller starts the driving of the pump, and the pump pours out the ink in the ink container 1 via the hollow needle and transports the ink toward the recording head.

The ink supply unit 100 includes a contact (not depicted) which is disposed in the unit housing 110 and with which the contact 31 of the IC memory 30 come into contact. In a case where the cartridge case 120 containing the ink container 1 is housed in the unit housing 110, the contact in the unit housing 110 and the contact 31 of the IC memory 30 come into contact with each other. The controller reads various information stored in the IC memory 30 at a predetermined timing, stores the read information in a memory (not depicted) in the controller, and use the stored information for the controlling process.

In a case where the ink supply unit 100 continues to supply the ink to the recording head and the ink in the ink container 1 runs out, a user takes the cartridge case 120 out of the ink supply unit 100 according to the procedure being the reverse of the procedure for housing the cartridge case 120 in the ink supply unit 100, and takes the ink container 1 housed in the cartridge case 120 out of the cartridge case 120 to replace the ink container 1 with a new ink container 1. Then, the user houses the cartridge case 120 containing the new ink container 1 in the ink supply unit 100.

In such a manner, the ink container 1 is used in a state that the ink container is housed in the cartridge case 120. The ink container 1 is housed in the cartridge case 120 in an orientation in which the contact 31 of the IC memory 30 is exposed via the opening 122 of the cartridge case 120, and the width direction of the container body 10 matches the up-down direction of the cartridge case 120. In other words, the ink container 1 is aligned in the cartridge case 120 using the orientation of the screw cap 20 as the reference. Therefore, if the positioning relationship between the screw cap 20 and the container body 10 is not appropriately aligned, the ink container 1 will not fit the cartridge case 120 appropriately in a case where the container body 10 is housed in the cartridge case 120. Here, the appropriate positioning relationship is specifically the positional relationship in which the marker 29 is aligned with the center of the container body 10 in the width direction as seen in the direction in which the hollow needle is inserted.

In a case where the screw cap 20 is screwed into the outlet 12 of the container body 10 and screwing has been completed, the positional relationship between the screw cap 20 and the container body 10 may not be in the appropriate positional relationship. In such a case, adjusting the positional relationship between the screw cap 20 and the container body 10 is required before and/or after the completion of the screwing. In this situation, if the screw cap 20 is attached to the container body 10 only by screwing between the female screw 25A screw cut on the inner circumferential surface 25 of the screw cap body 21 and the male screw 13A screw cut on the outer circumferential surface 13 of the outlet 12, then the positional relationship between the screw cap 20 and the container body 10 can be adjusted easily by screwing the screw cap 20 further into the container body 10 or rotating the screw cap 20 in a direction reverse to the direction for screwing the screw cap 20 into the container body 10.

However, normally, the screw cap body 21 and/or the outlet 12 are/is equipped with a reverse rotation prevention mechanism to prevent unprepared detachment of the screw cap 20 from the container body 10 which is caused by the reverse rotation of the screw cap 20 after the screw cap 20 has been screwed into the outlet 12 and which results in leaking of the ink. Therefore, in some cases, rotating the screw cap 20 reversely to adjust the positional relationship between the screw cap 20 and the container body 10 may be difficult. The ink container 1 of the present embodiment is configured to address this problem.

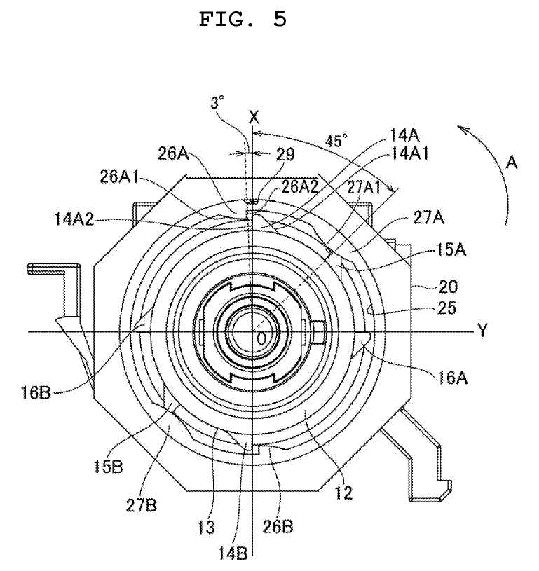

FIG. 5 is a view seeing the state in which the screw cap 20 has been screwed into the outlet 12, from the base of the outlet 12. In FIG. 5, two-dimensional cartesian coordinates are defined, with the center O of the outlet 12 as the origin, the axis passing through the center of the marker 29 as the X axis, and the axis orthogonal to the X axis as the Y axis. In FIG. 5, the direction indicated by the arrow A indicates the direction of screw-in rotation of the screw cap 20.

As depicted in FIG. 5, six projections 14A, 15A, 16A, 14B, 15B, 16B are disposed on the outer circumferential surface 13 of the outlet 12 to project in a direction away from the center O at a position adjacent to the base of the outlet 12. The position is, specifically, a position adjacent to the bottom of the male screw 13A screw cut on the outer circumferential surface 13 and a position where the tip of the screw cap 20 can cover from the outside in a case where the screw cap 20 has been screwed into the outlet 12. Three projections 14A, 15A, 16A are adjacent to each other, and three projections 14B, 15B, 16B are adjacent to each other. Since the projections 14A, 15A, 16A, 14B, 15B, 16B have the same shape with each other, the specific shape of the projections will be described using the projection 14A as the representative.

The projection 14A is composed of an inclined part 14A1 and an interfering part 14A2. The interfering part 14A2 has a shape rising from the outer circumferential surface 13 substantially orthogonally, for example at an angle of, for example, 80° to 90°. The inclined part 14A1 is continuous with the interfering part 14A2 and is continuous with the outer circumferential surface 13. An angle of inclination of the inclined part 14A1 with respect to the outer circumferential surface 13 is a predetermined angle, for example, 15° to 45°. The inclination direction of the inclined part 14A1 and the inclination direction of the interfering part 14A2 are different from each other. The inclination of the inclined part 14A1 is smaller than the inclination of the interfering part 14A2.

The projection 15A is disposed at a position obtained by rotating the projection 14A clockwise around the center O by, for example, 45°. Similarly, the projection 16A is disposed at a position obtained by rotating the projection 15A clockwise around the center O by, for example, 45°. That is, the projection 16A is disposed at a position obtained by rotating the projection 14A clockwise around the center O by 90°. The projection 14B is disposed at a position obtained by rotating the projection 14A around the center O by 180°. Similarly, the projections 15B and 16B are disposed at position obtained by rotating the projections 15A and 16A around the center O by 180°, respectively.

On the other hand, a first convex part 26A and a second convex part 27A, a first convex part 26B and a second convex part 27B are disposed on the inner circumferential surface 25 of the screw cap body 21 to project in a direction toward the center O. The first convex part 26A and the first convex part 26B have the same shape as each other, and the first convex part 26B is disposed at a position obtained by rotating the first convex part 26A by 180° around the center O. The second convex part 27A and the second convex part 27B have the same shape as each other, and the second convex part 27B is disposed at a position obtained by rotating the second convex part 27A by 180° around the center O.

Like the projection 14A, the first convex part 26A is composed of an inclined part 26A1 and an interfering part 26A2. The interfering part 26A2 has a shape rising from the inner circumferential surface 25 substantially orthogonally, at an angle of, for example, 80° to 100°. The inclined part 26A1 is continuous with the interfering part 26A2 and is continuous with the inner circumferential surface 25. An angle of inclination of the inclined part 26A1 with respect to the inner circumferential surface 25 is a predetermined angle, for example, 15° to 30°. The inclination direction of the inclined part 26A1 and the inclination direction of the interfering part 26A2 are different from each other. The inclination of the inclined part 26A1 is smaller than the inclination of the interfering part 26A2. In a case where the screw cap 20 is screwed into the outlet 12, the inclined part 26A1 makes contact with the inclined part 14A1 of the projection 14A so as to allow the projection 14A to pass through the inclined part 26A1. FIG. 5 depicts the state immediately after the inclined part 26A1 of the first convex part 26A has allowed the projection 14A to pass through the inclined part 26A1. On the other hand, the interfering part 26A2 interferes with the projection 14A (the interfering part 14A2 of the projection 14A) to prevent the screw cap 20 from rotating in the direction reverse to the screw-in rotation direction. In FIG. 5, if the screw cap 20 is rotated by 3° in the direction reverse to the screw-in rotation direction, the interfering part 26A2 of the first convex part 26A interferes with the projection 14A, and further reserve rotation of the screw cap 20 is prevented.

Note that, the angle of "3°" is the angle between the X axis and the straight line, indicated by a dashed line, connecting the interfering part 26A2 of the first convex part 26A and the center O. Since the X axis is a straight line passing through the center of the marker 29 and the center O as described above, in a state that the marker 29 faces front, the interfering part 26A2 of the first convex part 26A does not interfere with the projection 14A. If the screw cap 20 is rotated in the direction reverse to the screw-in rotation direction by 3° from a state in which the marker 29 faces front, the interfering part 26A2 of the first convex part 26A interferes with the projection 14A. In other words, "3°" is provided as a play angle. However, there is no limitation to this. No play angle may be provided, or a play angle other than "3°" may be adopted.

The second convex part 27A has a shape that rises gradually from the inner circumferential surface 25 and descends gradually to connect with the inner circumferential surface 25 after having reached at the apex 27A1. Further, the second convex part 27A of the present embodiment has a shape in which the shape of the first half part and the shape of the second half part divided from each other by a reference straight line extending from the center O and passing the apex 27A1 are line symmetrical with respect to the reference straight line, and smoothly connected to each other at the apex 27A1. In a case where the screw cap 20 is screwed into the outlet 12, the second convex part 27A makes contact with the inclined part 14A1 of the projection 14A to allow the projection 14A to pass through the second convex part 27A. Since the second convex part 27A is inclined even though the inclination is gradual, in a case where the second convex part 27A makes contact with the projection 14A, a friction force in the rotation direction is caused between the second convex part 27A and the projection 14A. Since the second convex part 27A does not include the interfering part 26A2 unlike the first convex part 26A, the second convex part 27A allows the projection 14A to pass through the second convex part 27A in both of the screw-in rotation direction and the direction reverse to the screw-in rotation direction of the screw cap 20. The second convex part 27A may be formed as a hollow structure. If the second convex part 27A is formed as the hollow structure, the second convex part 27A deforms more easily in a case where the projection 14A makes contact with the second convex part 27A, and thus passing of the projection 14A through the second convex part 27A can be performed more smoothly. Further, the maximum height of the second convex part 27A in the direction toward the center O, that is a height of the second convex part 27A from the inner circumferential surface 25 to the apex 27A1, is less than the maximum height of the first convex part 26A, that is a height of the first convex part 26A from the inner circumferential surface 25 to the apex of the interfering part 26A2. This ensures the interference between the interfering part 26A2 of the first convex part 26A and the projection 14A, and thus occurrence of reverse rotation of the screw cap 20 can be restrained assuredly. On the other hand, the second convex part 27A allows the projection 14A to pass through the second convex part 27A more smoothly.

As described above, a shape of the first convex part 26B and a shape of the second convex part 27B are same as or similar to the shape of the first convex part 26A and the shape of the second convex part 27A, respectively, and thus a description of those shapes will be omitted.

The interfering part 26A2 of the first convex part 26A and the apex 27A1 of the second convex part 27A are separated from each other by, for example, a rotation angle of 3° + 45°, with center O as the rotation center. In such a manner, the second convex part 27A is disposed separating from the first convex part 26A by a predetermined range, and is located upstream of the first convex part 26A in the screw-in rotation direction.

In the following, a method for adjusting the positional relationship between the screw cap 20 and the container body 10 by using the ink container 1 configured as described above will be described.

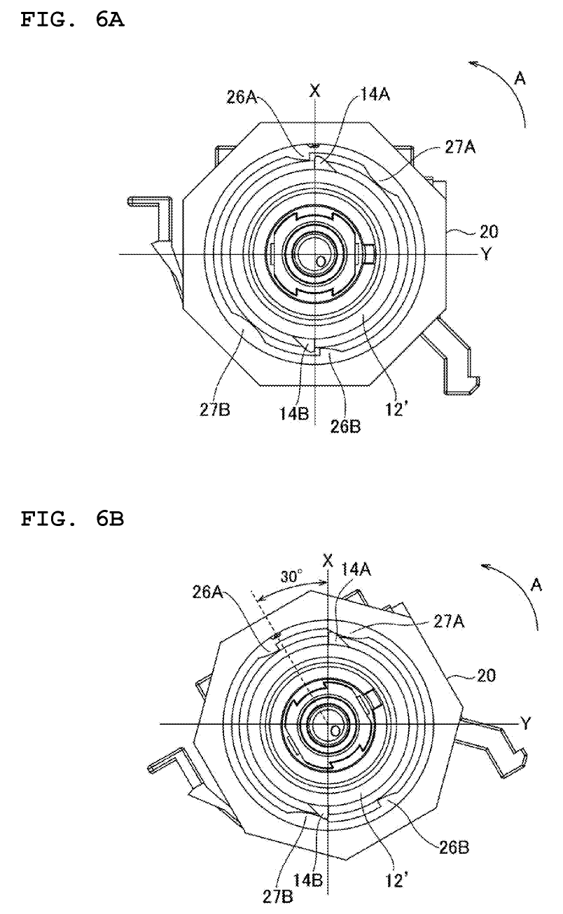

Suppose now that FIG. 5 depicts a state in a case where the adjusting of the positional relationship between the screw cap 20 and the container body 10 is about to start. Starting from the state depicted in FIG. 5, if the screw cap 20 is further screwed into the outlet 12, the screw cap 20 rotates in the screw-in rotation direction, that is the direction indicated by the arrow A, and thus the interfering part 26A2 of the first convex part 26A separates from the interfering part 14A2 of the projection 14A. Then, the second convex part 27A approaches the inclined part 14A1 of the projection 14A, and the state between the projection 14A (the inclined part 14A1 of the projection 14A) and the second convex part 27A turns from the non-contact state to the contact state. FIG. 6B depicts the state in which the state between the projection 14A and the second convex part 27A has turned from the non-contact state to the contact state. Note that, FIG. 6A and FIG. 6B are each a view of the state in which the screw cap 20 has been screwed into the outlet 12’ having two projections 14A, 14B disposed on the outer circumferential surface 13 to project from the outer circumferential surface 13, seeing from the base of the outlet 12’. That is, the number of projections disposed on the outer circumferential surface 13 of the outlet 12’ to project from the outer circumferential surface 13 of FIG. 6A and FIG. 6B is different from the number of projections disposed on the outer circumferential surface 13 of the outlet 12 to project from the outer circumferential surface 13 of FIG. 5. However, in describing the method for adjusting the positional relationship between the screw cap 20 and the container body 10 focusing on one projection 14A and first convex part 26A and a second convex part 27A with which the one projection 14A makes contact, FIG. 5 and FIGS. 6A and 6B can be referred substantially the same manner. Thus, in view of the convenience, the description will be made with reference to FIGS. 6A and 6B. Note that, FIG. 6A depicts the state in which the screw cap 20 has been screwed into the outlet 12, like FIG. 5.

As depicted in FIG. 6B, the angle of rotation of the screw cap 20 in a case where the screw cap 20 has been screwed into the outlet 12 from the position depicted in FIG. 6A to the position depicted in FIG. 6B is, for example, 30°.

In a case where the state between the projection 14A and the second convex part 27A changes from the non-contact state to the contact state, the friction force between the second convex part 27A and the projection 14A occurs in the rotation direction, and thus the operator feels pressure on his/her hand performing screwing of the screw cap 20 into the outlet 12. This allows the operator to feel that the screw cap 20 has reached at the upper limit (that is, a limit on the downstream side in the screw-in rotation direction) of the appropriate screw-in amount range.

After the state between the projection 14A and the second convex part 27A has changed from the non-contact state to the contact state, if the screwing of the screw cap 20 into the outlet 12 is continued, the contact state between the projection 14A and the second convex part 27A is maintained within a range of a rotation angle of 30° in this embodiment, in the screw-in rotation direction, that is, in the direction indicated by the arrow A. After that, the state between the projection 14A and the second convex part 27A has changed from the contact state to the non-contact state. This range of rotation angle defines the period during which pressure is felt by the hand of the operator, and the range is provided to make the operator perceive that he/she is screwing the screw cap 20 into the outlet 12 too much (screwing the screw cap 20 into the outlet 12 beyond the upper limit of the appropriate screw-in amount range). This range of the rotation angle can be varied depending on the shape set as the second convex part 27A. Preferably, the range may be set as the range of 5° to 45°.

On the other hand, if the screw cap 20 is rotated from the state depicted in FIG. 6A in the direction reserve to the screw-in rotation direction, that is the direction reverse to the direction indicated by the arrow A, after the screw cap 20 has been rotated by 3° (see FIG. 5), the interfering portion 26A2 of the first convex part 26A and the projection 14A (the interfering part 14A2 of the projection 14A) interfere with each other, and further reverse rotation of the screw cap 20 is restrained. The position where the interfering part 26A2 of the first convex part 26A and the projection 14A interfere with each other is the lower limit (that is, a limit on the upstream side in the screw-in rotation direction) of the range of the appropriate screw-in amount.

As described above, the range of the appropriate screw-in amount set in the present embodiment is the range of which lower limit is the position where the projection 14A interferes with the interference portion 26A2 of the first convex shape 26A and of which upper limit is the position where the projection 14A makes contact with the second convex part 27A. The range of the appropriate screw-in amount, expressed in terms of a rotation angle with the center O as the axis of rotation, is 3° + 30°. Within this range, the operator can screw in or reverse the screw cap 20 without feeling any particular pressure on his/her hand. That is, the rotation angle of the screw cap 20 having been screwed into the outlet 12 at a timing immediately after the projection 14A has passed through the inclined part 26A1 of the convex part 26A is defined as 0° and the rotation angle of 0° is set to be the lower limit of the range of the appropriate screw-in amount. In this case, in a case where the screw cap 20 has been rotated by 3° + 30° thereafter, the state between the projection 14A and the second convex part 27A changes from the non-contact state to the contact state. The rotation angle of 3° + 30° is the upper limit of the range of the appropriate screw-in amount.

Since the lower limit and the upper limit of the range of the appropriate screw-in amount are defined as described above, the operator can adjust the positional relationship between the screw cap and the container body between the lower and upper limits of the range of the appropriate screw-in amount, while restraining the reverse rotation. Even if the upper limit of the range of the appropriate screw-in amount is exceeded, the second convex part 27A allows the projection 14A to pass through the second convex part 27A, and thus the operator can return the screw cap 20 in the direction reverse to the screw-in rotation direction until the screw cap 20 reaches the lower limit of the range of the appropriate screw-in amount.

Each of the projection 14A and the projection 14B is positioned such that if one of the projection 14A and the projection 14B is rotated by 180° around the center O, the one of the projection 14A and the projection 14B is overlapped with the other of the projection 14A and the projection 14B. Thus, in a case where the state between the projection 14A and the second convex part 27A changes from the non-contact state to the contact state, the state between the projection 14B and the second convex part 27B also changes from the non-contact state to the contact state. Further, the second convex part 27A and the first convex part 26B may be omitted while maintaining the positional relationship between the projections 14A and 14B. In this case, if the projection 14A is used as a member to detect the lower limit of the range of the appropriate screw-in amount and the projection 14B is used as a member to detect the upper limit of the range of the appropriate screw-in amount, the adjustment of the positional relationship between the screw cap 20 and the container body 10 described above can be performed in the manner same as or similar to the manner described above.

In the above description, the method for adjusting the positional relationship between the screw cap 20 and the container body 10 is described focusing on one projection 14A and the first convex part 26A and the second convex part 27A with which the one projection 14A makes contact. However, the state when the adjustment of the positional relationship between the screw cap 20 and the container body 10 is about to be started is not limited to the state depicted in FIG. 5, and the projection positioned within the range of the appropriate screw-in amount may be another projection different from the projection 14A. Even in such a case, the positional relationship between the screw cap 20 and the container body 10 can be adjusted in the manner same as or similar to the manner described above, by simply replacing the projection 14A with another projection.

As described above, the ink container 1 of the present embodiment includes the container body 10 including the outlet 12 having a cylindrical shape, the male screw 13A being formed on the outer circumferential surface 13 of the outlet 12; and the screw cap 20 having a cylindrical shape, the female screw 25A being formed on the inner circumferential surface 25 of the screw cap 20, the screw cap 20 being configured to be screwed into the outlet 12 in a state that the outer circumferential surface 13 of the outlet 12 and the inner circumferential surface 25 of the screw cap 20 face each other. The outlet 12 includes the projection 14A disposed, on the outer circumferential surface 13, at a position adjacent to the base of the cylindrical shape of the outlet 12. The screw cap 20 includes: the first convex part 26A which is disposed on the inner circumferential surface 25 and which has the inclined part 26A1 and the interfering part 26A2, the inclined part 26A1 being configured to allow the projection 14A to pass through the first convex part 26A in a case where the screw cap 20 is rotated in a first direction of a rotation direction to be screwed into the outlet 12, the interfering part 26A2 being configured to interfere with the projection 14A to prevent the screw cap 20 from rotating in a second direction, opposite to the first direction, of the rotation direction; and the second convex part 27A configured to allow the projection 14A to pass through the second convex part 27A, and to come into contact with the projection 14A so as to cause a friction force in the rotation direction, in a case where the screw cap 20 is screwed into the outlet 12.

As described above, in the ink container 1 of the present embodiment, in a case where the screw cap 20 is screwed into the outlet 12, the first convex part 26A and the second convex part 27A of the screw cap 20 pass through the projection 14A of the outlet 12. Then, in a case where the screw-in amount is excessive and the screw cap 20 is rotated in the direction reverse to the screw-in rotation direction to cancel the excessive screw-in amount, even if the projection 14A is in contact with the second convex part 27A, the screw cap 20 can be screwed back until the projection 14A interferes with the interfering part 26A2 of the first convex part 26A. In a case where the screw cap 20 is further screwed into the outlet 12 thereafter, the projection 14A makes contact with the second convex part 27A and a friction force in the rotation direction is caused between the projection 14A and the second convex part 27A, the operator feels pressure on his/her hand when screwing the screw cap 20 into the outlet 12. Thus, the operator can perceive that the present screw-in amount is in the range of appropriate screw-in amount.

The container body 10 has a configuration in which the outlet 12 made of resin is attached to a pouch made of film material, and the container body 10 can contain the ink of ultraviolet curing type.

A range of an appropriate screw-in amount with respect to the outlet 12 is set for the screw cap 20; and the projection 14A and the interfering part 26A2 of the first convex part 26A are disposed so as to interfere with each other at a timing when the screw cap 20 screwed into the outlet 12 reaches a lower limit of the range of the appropriate screw-in amount. Based on such configuration, the operator cannot rotate the screw cap 20 in the direction reverse to the screw-in direction over the lower limit of the range of the appropriate screw-in amount, and thus reverse rotation of the screw cap 20 is restrained.

The range of the appropriate screw-in amount with respect to the outlet 12 is set for the screw cap 20; and the projection 14A and the second convex part 27A are disposed so as to change from a state in which the projection 14A and the second convex part 27A are not in contact with each other to a state in which the projection 14A and the second convex part 27A are in contact with each other, at a timing when the screw cap 20 screwed into the outlet 12 reaches the upper limit of the range of the appropriate screw-in amount. Based on such configuration, the friction force in the rotation direction is caused between the projection 14A and the second convex part 27A, and the operator feels pressure on his/her hand when screwing the screw cap 20 into the outlet 12. Thus, the operator can perceive that the present screw-in amount is out of the range of appropriate screw-in amount.

The second convex part 27A is disposed upstream, in the screw-in rotation direction of the screw cap 20, of the first convex part 26A, and is separated from the first convex part 26A by the range of the appropriate screw-in amount. Based on such configuration, the lower limit of the range of the appropriate screw-in amount is defined by the first convex part 26A and the upper limit of the range of appropriate screw-in amount is defined by the second convex part 27A.

The projection 14A, 14B includes a first projection 14A, and a second projection 14B disposed downstream, in the screw-in rotation direction of the screw cap 20, of the first projection 14A; the range of the appropriate screw-in amount with respect to the outlet 12 is set for the screw cap 20; and the first projection 14A and the interfering part 26A2 of the first convex part 26A are disposed so as to interfere with each other at a timing when the screw cap 20 screwed into the outlet 12 reaches the lower limit of the range of the appropriate screw-in amount; and the second projection 14B and the second convex part 27B are disposed so as to change from a state in which the second projection 14B and the second convex part 27B are not in contact with each other to a state in which the second projection 14B and the second convex part 27B are in contact with each other, at a timing when the screw cap 20 screwed into the outlet 12 reaches the upper limit of the range of the appropriate screw-in amount.

Based on the above configuration, the first projection 14A can be functioned as a member to notify the lower limit of the range of the appropriate screw-in amount to the operator, and the second projection 14B can be functioned as a member to notify the upper limit of the range of the appropriate screw-in amount to the operator. That is, the lower limit and the upper limit of the range of the appropriate screw-in amount can be notified to the operator by using two projections being the first projection 14A and the second projection 14B rather than notifying both of the lower limit and the upper limit of the range of the appropriate screw-in amount to the operator by using one projection being the projection 14A.

The maximum height of the second convex part 27A in a direction from the inner circumferential surface 25 of the screw cap 20 towards an axial center of the outlet 12 is equal to or smaller than a maximum height of the first convex part 26A in the direction from the inner circumferential surface 25 of the screw cap 20 towards the axial center of the outlet 12. Based on such configuration, the interference between the interfering part 26A2 of the first convex part 26A and the projection 14A is assured, and thus the reverse rotation of the screw cap 20 can be restrained assuredly. On the other hand, the second convex part 27A can allow the projection 14A to pass through the second convex part 27A more smoothly.

The second convex part 27A has a hollow part. Based on such configuration, the second convex part 27A is easy to deform in a case where the projection 14A makes contact with the second convex part 27A, and thus the second convex part 27A can allow the projection 14A to pass through the second convex part 27A more smoothly.

The screw cap 20 has the IC memory 30, and the contact 31 of the IC memory 30 is exposed to the outside. Thus, in a case where making contact with the contact 31 of the IC memory 30, preparing only a contact is satisfactory, and there is no need to prepare special connector or the like.

The screw cap 20 includes a receiving hole 23 configured to receive a hollow needle inserted into the receiving hole 23 from the outside; and a valve mechanism 24 configured to open or close depending on whether the hollow needle inserted into the receiving hole 23 presents. Based on such configuration, the valve mechanism 24 turns to the open state by inserting the hollow needle into the receiving hole 23 only, and thus the ink can be poured out from the ink container 1 immediately.

The projection 14A, 14B of the outlet 12 and the first convex part 26A, 26B and the second convex part 27A, 27B of the screw cap 20 are provided as a set in which the projection 14A, 14B of the outlet 12 and the first convex part 26A, 26B and the second convex part 27A, 27B of the screw cap 20 correspond to each other; and the liquid container 1 includes a plurality of the sets. Based on such configuration, in a case where the screw cap 20 is screwed into the outlet 12, loads applied onto the projection 14A, 14B, the first convex part 26A, 26B and the second convex part 27A, 27B of the screw cap 20 can be dispersed.

The second convex part 27A is configured to maintain contact with the projection 14A, in a range from 5° to 45° in the screw-in rotation direction from the upper limit of the range of the appropriate screw-in amount. Based on such configuration, the contact state in which the projection 14A and the second convex part 27A are in contact with each other is maintained in the above range, and the friction force in the rotation direction is caused between the projection 14A and the second convex part 27A during a period in which the contact state is maintained. Thus, the operator feels pressure on his/her hand when screwing the screw cap 20 into the outlet 12, and can perceive that the present screw-in amount is out of the range of the appropriate screw-in amount assuredly.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(1) In the above embodiments, the angle defining the upper limit of the range of the appropriate screw-in amount is exemplified by 30°, the play angle in a case where the mark 29 faces the front is exemplified by 3°, and the distance between the projection 14A and the projection 15A is exemplified by the rotation angle of 45°. However, angles other than those angles may be adopted.

(2) In the above embodiment, the projections 14A, 14B of the outlet 12 and the first convex parts 26A, 26B and the second convex parts 27A, 27B of the screw cap 20 are provided as a pair in which those parts correspond to each other, and two of the pair is provided. However, the number of the pair may be one, or three or more.

(3) The above embodiments are described referring to the outlet 12 having six projections 14A, 15A, 16A, 14B, 15B, 16B provided to project from the outer circumferential surface 13, and the outlet 12′ having two projections 14A, 14B provided to project from the outer circumferential surface 13. However, the number of projections may be one, three to five, or more than six.

(4) In the above embodiments, the ink container 1 is adopted as a liquid container and the UV ink is adopted as the ink to be contained in the ink container 1. However, inks other than the UV ink may be contained in the ink container 1. Further, the liquid to be contained in the liquid container may be a liquid other than ink.

(5) In the above embodiment, regarding the second convex part 27A, the first part and the second part of the second convex part 27A obtained by separating the second convex part 27A by the straight line extending from the center O to the apex 27A1 are line symmetric with each other. However, the first part and the second part may not be symmetric with each other. Similarly, the second convex part 27B may not have line symmetric shape

(6) In the above embodiment, the screw cap 20 has the IC memory 30, and the contact 31 of the IC memory 30 is exposed to the outside. However, the IC memory 30 and the contact 31 may be omitted. Instead, an alignment part or an engagement part configured for holding the ink outlet part 22 by the holding part 125 in a specific orientation may be formed on the screw cap 20.

What is claimed is:

1. A liquid container comprising:
a container body including an outlet having a cylindrical shape, a male screw being formed on an outer circumferential surface of the outlet; and
a screw cap having a cylindrical shape, a female screw being formed on an inner circumferential surface of the screw cap, the screw cap being configured to be screwed into the outlet in a state that the outer circumferential surface of the outlet and the inner circumferential surface of the screw cap face each other, wherein:
the outlet includes a projection disposed, on the outer circumferential surface of the outlet, at a position adjacent to a base of the cylindrical shape of the outlet; and
the screw cap includes:
a first convex part which is disposed on the inner circumferential surface of the screw cap and which has an inclined part and an interfering part, the inclined part being configured to allow the projection to pass through the first convex part in a case where the screw cap is rotated in a first direction of a rotation direction to be screwed into the outlet, the interfering part being configured to interfere with the projection to prevent the screw cap from rotating in a second direction, opposite to the first direction, of the rotation direction; and
a second convex part configured to allow the projection to pass through the second convex part, and to come into contact with the projection so as to cause a friction force in the rotation direction, in a case where the screw cap is screwed into the outlet.

2. The liquid container according to claim 1, wherein
the container body includes:
a pouch made of film material; and
the outlet, made of resin, attached to the pouch.

3. The liquid container according to claim 2, wherein
the container body is configured to contain an ink of ultraviolet curing type.

4. The liquid container according to claim 1, wherein
a range of an appropriate screw-in amount with respect to the outlet is set for the screw cap, and
the projection and the interfering part of the first convex part are disposed so as to interfere with each other at a timing when the screw cap screwed into the outlet reaches a lower limit of the range of the appropriate screw-in amount.

5. The liquid container according to claim 1, wherein
a range of an appropriate screw-in amount with respect to the outlet is set for the screw cap, and
the projection and the second convex part are disposed so as to change from a state in which the projection and the second convex part are not in contact with each other to a state in which the projection and the second convex part are in contact with each other, at a timing when the screw cap screwed into the outlet reaches an upper limit of the range of the appropriate screw-in amount.

6. The liquid container according to claim 5, wherein
the second convex part is disposed upstream, in the rotation direction, of the first convex part, and is separated from the first convex part by the range of the appropriate screw-in amount.

7. The liquid container according to claim 1, wherein
the projection includes a first projection, and a second projection disposed downstream, in the rotation direction, of the first projection,
a range of an appropriate screw-in amount with respect to the outlet is set for the screw cap,
the first projection and the interfering part of the first convex part are disposed so as to interfere with each other at a timing when the screw cap screwed into the outlet reaches a lower limit of the range of the appropriate screw-in amount, and
the second projection and the second convex part are disposed so as to change from a state in which the second projection and the second convex part are not in contact with each other to a state in which the second projection and the second convex part are in contact with each other, at a timing when the screw cap screwed into the outlet reaches an upper limit of the range of the appropriate screw-in amount.

8. The liquid container according to claim 1, wherein
a maximum height of the second convex part in a direction from the inner circumferential surface of the screw cap towards an axial center of the outlet is equal to or smaller than a maximum height of the first convex part in the direction from the inner circumferential surface of the screw cap towards the axial center of the outlet.

9. The liquid container according to claim 1, wherein
the second convex part has a hollow part.

10. The liquid container according to claim 1, wherein
the screw cap has a memory, and
a contact of the memory is exposed to an outside.

11. The liquid container according to claim 1, wherein
the screw cap includes:
a receiving hole configured to receive a hollow needle inserted into the receiving hole from an outside; and
a valve configured to open or close depending on whether the hollow needle inserted into the receiving hole presents.

12. The liquid container according to claim 1, wherein
the projection of the outlet and the first and second convex parts of the screw cap are provided as a set in which the projection of the outlet and the first and second convex parts of the screw cap correspond to each other, and
the liquid container includes a plurality of the sets.

13. The liquid container according to claim 5, wherein
the second convex part is configured to maintain contact with the projection, in a range from 5° to 45° in the first direction of the rotation direction from the upper limit of the range of the appropriate screw-in amount.
